(19) United States
(12) Patent Application Publication
(10) Pub. No.: US 2013/0173318 A1
(43) Pub. Date: Jul. 4, 2013

(54) Method, Apparatus and System for Perpetual Cyber Value Add Discount Process

(71) Applicant: Mohammad Shakaib Iqbal, Sunnyvale, CA (US)

(72) Inventor: Mohammad Shakaib Iqbal, Sunnyvale, CA (US)

(21) Appl. No.: 13/730,764

(22) Filed: Dec. 28, 2012

Related U.S. Application Data
(60) Provisional application No. 61/581,071, filed on Dec. 28, 2011.

(51) Int. Cl. G06Q 10/02

(52) U.S. Cl. CPC G06Q 10/02
USPC 705/5

(57) ABSTRACT

Method system, and apparatus for perpetual cyber value add discount process are provided. The method includes: A method for Perpetual Cyber Value Add Discount Process, comprising identifying a number of available tickets for a service provided by an organization which will be unused, selling the available tickets to a customer prior to the start of the service for which the ticket is bought, generating a sale confirmation number to the customer which allows the customer to access the service, and sending the sale confirmation number information to the customer and the organization providing the service.

### CROSS-REFERENCE TO RELATED APPLICATION

This application claims priority from U.S. Provisional Patent Application Ser. No. 61/581,071, filed on Dec. 28, 2011, the entire contents of which are incorporated herein by reference for all purposes.

### FIELD OF THE INVENTION

The present invention relates to network service, and more particularly, to methods apparatus and system for perpetual cyber value add discount process.

### BACKGROUND OF THE INVENTION′

The Internet is one of the most significant “game changers” of late last century. It has changed conventional human living practices across the board impacting psychological, cultural, social, educational, recreational and even economical norms. People in large masses from all over the world have quickly adapted the Internet as the preferred medium for communication, including, but not limited to acquiring information, socializing, trading/exchanging goods and services, advertising, etc. Consequently, the Internet has made it possible for businesses to reach previously unknown customers and develop almost any market to achieve their commercial or business objectives.

In the beginning, Internet suffered during the “Dot-Com bust” as thousands of businesses and enterprises swarmed it to establish themselves in the cyber market place. Unfortunately, many of them later discovered that their entry was premature sometimes in part due to the businesses lack of experience in the “cyber world” and sometimes because the masses that were attracted to Internet needed time to familiarize themselves with the medium and then develop their confidence for carrying out financial or other business transactions in cyber space. The Internet commercial potential really began evolving from 2000.

Since the dot corn bust hump, the Internet has progressed rapidly and has produced several note worthy companies such as Google®, Facebook® and Amazon®. In the entertainment industry also there are multiple examples of successful companies and websites that continue to emerge on an almost daily basis, offering various services and attractive commercial deals to the public.

The Internet is now well established as the preferred medium of marketing, and communication and is enabling enterprises to reach millions of new customers across the globe. Every new business, invention, new product or a new idea seeks to have presence and an internet marketing strategy in order to be successful. Along with the Internet such business now must also have mobile applications developed to reach the target mobile markets.

With the advent of the Internet and the ability to provide instantaneous advertising, there are opportunities for novel business models. For example, maximizing revenue based on usage which does not result in an increase cost to a business. For example, it is not uncommon for movie theaters or any other entertainment provider, to have empty seats during showings. Those empty seats are a direct and sometimes substantial loss revenue opportunity for the theater. As a result, there is a need to develop novel systems and methods for realizing revenue and preventing such losses.

### SUMMARY OF THE INVENTION

In order to realize revenue, such method and apparatus for perpetual cyber value add discount process are implemented across the Internet and through appropriate geographic regions. Therefore, embodiments of the present invention provide help businesses maximizing business revenues in close proximity to its consumers. In one embodiment the system and method provides for advising consumers of available tickets at the last minute for local venues and service, such as theater or sporting events and for multiple times.

A method for Perpetual Cyber Value Add Discount Process, comprising identifying a number of unused, available tickets for a service provided by an organization, selling the available tickets to a customer prior to the start of the service for which the ticket is bought, generating a sale confirmation number to the customer which allows the customer to access the service, and sending the sale confirmation number information to the customer and the organization providing the service.

An apparatus for Perpetual Cyber Value Add Discount Process, comprising, means for identifying a number of available unused tickets for a service provided by an organization, means for selling the available tickets to a customer prior to the during a short time window before the start of a service for which the ticket is bought, means for generating a sale confirmation number to the customer by using which the organization allows the customer to access the service, and means for sending the sale confirmation number information to the customer and the organization providing the service.

A computer-readable storage medium, comprising computer instructions which, responsive to being executed by a processor, cause the processor to perform operations comprising, identifying a number of available tickets for a service provided by an organization which are likely to remain unused, selling the available tickets to a customer prior to the start of the service for which the ticket is bought, generating a sale confirmation number to the customer which allows the customer to access the service; and sending the sale confirmation number information to the customer and the organization providing the service.

### BRIEF DESCRIPTION OF THE DRAWINGS

Although the scope of the present invention is much broader than any particular embodiment, a detailed description follows together with drawings. These drawings are for illustration purposes only and are not drawn to scale. Like numbers represent like featuers and components in the drawings. The invention may best be understood by reference to the ensuring detailed description in conjunction with the drawings in which:

FIG. 1 illustrates an exemplary flow diagram depicting the method for Perpetual Cyber Value Add Discount Process in one embodiment of the present invention.

FIG. 2 illustrates an exemplary User Interface (“UI”) depicting an exemplary website providing Perpetual Cyber Value Add Discount Process in one embodiment of the present invention.

FIG. 3 illustrates an exemplary UI depicting an exemplary website providing Discount Movie Ticket in one embodiment of the present invention.

FIG. 4 illustrates an exemplary flow diagram depicting an exemplary method for Movie Ticket Discount Process in one embodiment of the present invention.

FIG. 5 illustrates an exemplary block diagram generally illustrating an exemplary system for Perpetual Cyber Value Add Discount Process in one embodiment of the present invention.

FIG. 6 illustrates an exemplary UI depicting the distance and time it takes the customer to reach an exemplary service venue.

### DETAILED DESCRIPTION OF THE INVENTION

The embodiments of the present invention are described more fully hereinafter with reference to the accompanying drawings, which form a part hereof, and which show, by way of illustration, specific exemplary embodiments by which the invention may be practiced. This invention may, however, embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as systems, methods or devices. The following detailed description should not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” The term “coupled” implies that the elements may be directly connected together or may be coupled through one or more intervening elements. Further reference may be made to an embodiment where a component is implemented and multiple like or identical components are implemented.

While the embodiments make reference to certain events this is not intended to be a limitation of the embodiments of the present invention and such is equally applicable to any event where goods or services are offered to a consumer.

Further, the order of the steps in the present embodiment is exemplary and is not intended to be a limitation on the embodiments of the present invention, it is contemplated that the present invention includes the process being practiced in other orders and/or with intermediary steps and/or processes.

At a high level, embodiments of the present invention include the ability to monetize “Last Minute” (for example, in one embodiment, 45 minutes before) unsold tickets for any event and/or service without expenditure of additional funds by the organizers. The event and/or service may include, but are not limited to movies, cinemas, theaters, concerts, games, fundraisers, air travel tickets, train tickets, bus travel tickets, amusement parks, cruises, hotels, motels, car rentals or any form of service or event, including but not limited to social, entertainment, religious, political, educational, or other events. Embodiments of the present invention provide a system that allows “last minute” intelligent and/or strategic planning by the management to maximize profits. For example, in an embodiment of the present invention, the management of the event will be able to reduce the number of seats that will go empty, taking into consideration all logistic factors ensuring that the buyer/consumer reaches the event comfortably and be able to enjoy the intended event, while getting his money and efforts worth.

Unlike currently available discounts and special offers which traditionally are solely “time based”, for example. Matinee versus Prime, the embodiments of the present invention take the business model beyond the matinee time limitation into the “Prime” domain at the same price.

While embodiments of the present invention are presented in relation to theater and other spectator events, the embodiments of the present invention are not so limited and it is contemplated within the scope of the present invention that the embodiments are equally applicable to all event Industries (including services), where revenue is based on issuance of tickets/seats/rental fee, etc., including but not limited to air travel; land travel (bus, tours, trains), concerts, games, cruises, fund raisers (per seat), award/show ceremonies, museum tours, amusement parks, lodging (hotels, motels), or any other form of event.

The embodiments presented herein provide for example a mechanism to fill as many empty seats possible to monetize the supplementary revenue for every show. Such systems and methods accomplish this by a cyber-mechanism that is accessible from anywhere and at any time. The novel systems and methods presented herein will allow consumers to buy tickets at discount prices but only during a short time window which will be operative for a short time before or after the start of the main events. The tickets are provided for a short window of time (to avoid any impact on full revenue seats).

In one embodiment, the systems and methods described herein work efficiently because: FIRST, a definitive number of seats which are most probable of ending up unfilled or empty are identified/decided, and

SECOND, the seats are sold to the buyers (at discount prices) who have enough time and can manage to reach the theater/event before or shortly after the start of the main event.

In one exemplary embodiment of the present invention, discounted cost entertainment is provided to the consumer. Consumers can make “last minute” plans and acquire tickets creating additional excitement. Friends, groups, peers, co-workers, family members, all participate in the thrill of taking tickets to a last minute event. Further, the added excitement enables consumers to enjoy prime events at discount prices. In one exemplary embodiment, consumers also have access to additional offers, discounts, and information on other brand products and services.

In one embodiment of the present invention, the systems and methods presented herein could be implemented in various ways, including but not limited to, a card system that may include a prepaid credit card for that particular subscriber who would preload his account for “One Click” for one click ticket/service purchase when necessary (avoiding the hassles of verification that is required in purchase on Visa, MC, AmEx, Discover, etc.).

In one embodiment of the present invention, the systems and methods presented herein could be implemented as an advertisement platform, where the planned “last minute” sales would begin as short time, for example half an hour or forty-five minutes prior to the start of the event, customers would be able to log in waiting, for the Ticket selling to begin. During this period the customers would represent a captive audience. As a result, there is an opportunity to generate revenue from 3rd party advertisements and other marketing opportunities.

In one embodiment of the present invention, the systems and methods presented herein could be implemented as a product marketing platform where retail marketing companies, for example HSBC Retail Services, could sign up to sell their products. In addition such marketing could be targeted to the customers, for example based on subject matter of the venue or event and the anticipated demographics of the customers as a social network platform. Similarly the events on social networks could be advertised during this time slot when large captive e audience will be on line. Other social networking could also be done like letting friends know what show you are planning to go see or what venue you will be at. The site could also allow for reviews and commentary about the events or venues that may be shared among customers.

In one embodiment of the present invention, the systems and methods presented herein could be implemented so that government special announcements as well as local city announcements can also be supported, because a captive audience could potentially be on the website for periods of time.

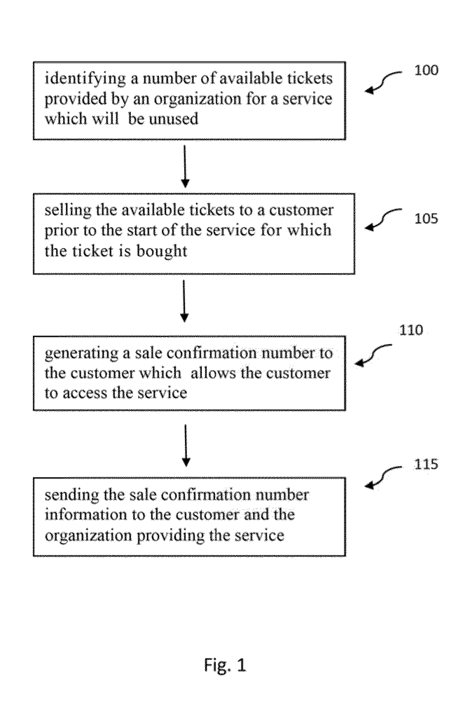

FIG. 1 illustrates an exemplary flow diagram depicting a method for Perpetual Cyber Value Add Discount Process in one embodiment of the present invention. As shown in FIG. 1, the method comprises the steps of:

Step 100: identifying a number of available tickets which are unused or which will most probably end up unfilled or empty. In one embodiment, the number of available tickets which are most probable of ending up unfilled or empty is received from an organization providing the service.

Step 105: selling the available tickets to a customer prior to the start of the service for which the ticket is brought. In one embodiment, the time prior to the start of the service will vary from service to service. For example, in one event, the time prior to the start of service can mean before the climax of the event.

Step 110: generating, a sale confirmation number to the customer which allows the customer to access the service.

Step 115: sending the sale confirmation number information to the customer and the organization providing the service. In one embodiment, if the method is implemented and the corresponding website is run by a third party other than the organization, the sale confirmation number will also be sent to the third party.

In one embodiment, the number of available tickets which most probably will end up unfilled or empty may be determined by seat availability data.

In one embodiment, the seat availability data may be provided in a variety of ways. In one embodiment the seat availability is provided dynamically, however this is not intended to be a limitation on the embodiments of the present invention. If seat availability is done on a dynamic basis, it may be done in a variety of ways including by means of a dynamic (i.e., digital internet) feed from the participating organization. In one embodiment, the digital internet feed may also include information directly inputted into the organization's database or information obtained from personnel or from video camera technology. In another embodiment, the seat availability may be provided in a static format including a fix number, fixed percentage or other set amount of tickets.

In one embodiment, additional options of ticket purchasing modules are provided. One exemplary option is prior credit verification and prior money load-up of deposit for one click ticket purchasing. The mechanism will allow the customer to preload his account on the service provider's website using his own credit card or debit card before the “Last Minute” sales begin. If the customer has already loaded funds on his/her service account, “One click. Purchase” mechanism can be provided. The customer will get the “Purchase (sale) Confirmation number” immediately allowing him/her to proceed to the event with no further waiting period. Purchasing tickets with “One Click Purchase” feature will let the customer have extra time to travel to the event. In one embodiment, another option is regular or ordinary purchasing option, where the credit card verification occurs as the ticket is purchased. While less desirable, such embodiments are contemplated within the scope of the embodiments of the present invention however making payment through regular credit cards may take a little more time for obtaining confirmation.

In one embodiment, the method also provides dynamic ticket updating so that if a ticket is sold, the number of available tickets is automatically appropriately adjusted. The discretion is left to the event organizer's management, to monitor sales and allocate a certain number of seats when the event organizer's management reaches the time when it thinks those seats will go empty.

In one embodiment, minute relevant and timely messaging (i.e., House Full or Sold out, whatever the case may be) may be displayed on that location's or the particular organization's web screen display.

Because of the dynamic nature, embodiments of the present invention rely on continued communication between the venue and the website furnishing the information regarding potential unfilled seats beginning a certain time before the starting, time of the main feature/event/service on the respective screen.

In one embodiment, in order to not impact the regular priced, ticket business, setting a short time ticket selling window for the discount ticket selling may be preferred.

In one embodiment the ticket selling window will open the sales on every screen a certain time prior to the start of main feature/event/service and will only keep it open for a preset time, just leaving several minutes or so for the purchaser to get to the service provider location for which the purchaser purchased the tickets. For example, the certain time prior to the start of main event is dependent on how long the customer costs to reach the event comfortably and be able to enjoy the intended service.

Embodiments of the present invention described herein are based on a minimum empty seat allocation required per screen or event. This may vary with venue, event, day of the week, or any other variable which may contribute to availability.

The discount rate or price of the tickets will be set prior to the offering and may vary with the time before show or event, i.e., it could in some embodiments be further reduced with mutual agreement with the event/service provider or organizer.

In one embodiment, an algorithm (may be mathematical formula) in the database for calculating flexible discount to bring maximum benefits (revenues) is provided. For example, matinee discount is roughly 40% but it only gives liberty to give flat 40% discount. In one embodiment, a flexible discount arrangement (for example, from 30 to 60%) may be proposed, or and varying discounts (for example, 60% discount on 10% tickets; 50% discount on 15% tickets; 40% discount on 15% tickets; 35% discount on 50% tickets and 10% discount on 10% tickets may be provided to customers. In one embodiment, 35% discount is a “Sweet Spot” which generates more revenue.

The “Feed Portion” of an embodiment of the present invention provide for receiving data i.e. available tickets) from the business partner, e.g., the event sponsor, airline, hotel, train. In one embodiment, the business partner will provide dynamic data feed through their “ticket” sales system and from their servers to the receiving/managing entity secured Application Programming Interface, (“API”) intended to be used as an interface by software components to communicate with each other. An API may include specifications for routines, data structures, object classes, and variables on the availability of the event, the tickets. As the businesses would want to be able to sell their tickets, seats etc., at regular price till the last minute themselves, embodiments of the present invention provide a unique method that will allow them to allocate the “Last Minute” seats/tickets as well as keep selling the tickets themselves if possible. The subject business will make a decision before the start of the main event, for example, an hour before the event, about how many seats/tickets are to be allocated for “Last Minute” sales. The business software will place this bank of seats/tickets in a counter where both the business itself and the system disclosed herein will have access. The ticket traffic coming through the system herein and that from the business itself will make the sales and the counter will keep updating the remaining number of seats/tickets till all the tickets are gone. At this instance the Ticket Bank Window in the system and the business both will display “Sold Out”.

In one embodiment, seat availability data is searched based on genre, location, price or the like. For example a user could query. “What movies are available within 5 miles of my current location”, “what comedy shows have availability in a specific geographic areas,” “what shows start in the next 15 minutes”.

In another embodiment, social networking, is integrated to enable a user to share information for example regarding a show he or she may be going to, availability of tickets for a group meet up, where another person is so that they can decide on an event or function at which to meet.

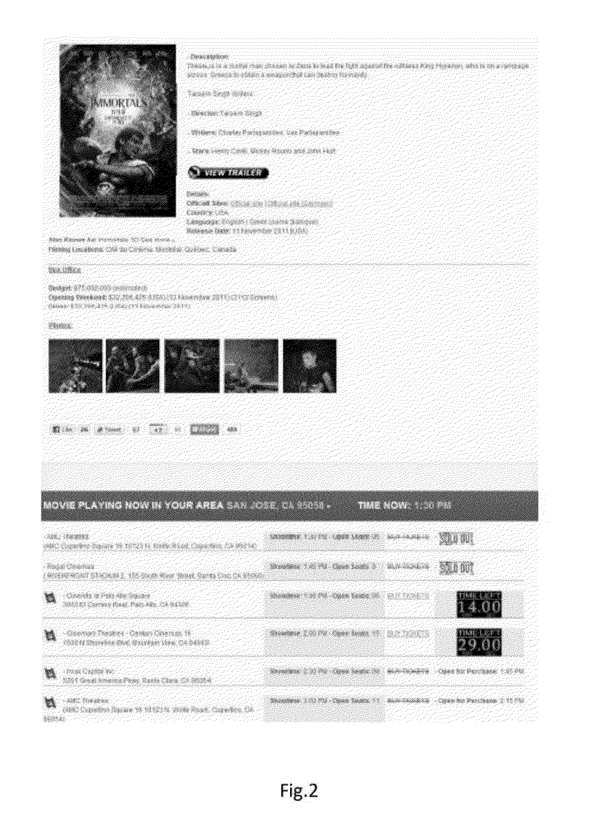

In one embodiment, a website for Perpetual Cyber Value Add Discount Process is implemented. FIG. 2 illustrates an exemplary UI depicting a website providing Discount Movie Ticket in one embodiment of the present invention. As shown in FIG. 2, the website requires registration including the members building a profile so target offers may also be sent to the member. In one embodiment, the profile may include the following:

The Address/Zip Code based location that or with the list of nearest theater clusters with the target Theater/Cluster selection option (Google maps for each location);

The list of the movies playing with target movie selection option;

The show timings with the showings for that day, with target show selection option;

The tickets availability window with a Countdown timer that will start counting down a preset minutes prior to the opening of the ticket sale; in the one embodiment, the Countdown timer that will start counting down 15 minutes prior to the opening of the ticket sale;

The number of tickets available for sale information window (right below the countdown timer). This number of tickets offered/available will have a countdown (depletion) feature that will decrease as the tickets available for sale get sold.

The back end of the website is integrated/linked with all theaters/theater clusters of the Theater Chain's websites consistent with arrangements made, including but not limited to contractual relationships with the theater chains. The theater/theater clusters chain then provides timely or contemporaneous availability of the empty seats information per each participating theater/theater cluster respectively.

If seat availability is done on a dynamic basis, it may be done in a variety of ways including by means of three dynamic (i.e., digital internet) feeds from the participating organization. The feeds include: particular event/show time; number of tickets allocated; and interactive communication feed generating sale confirmation numbers for the customers until all tickets are sold.

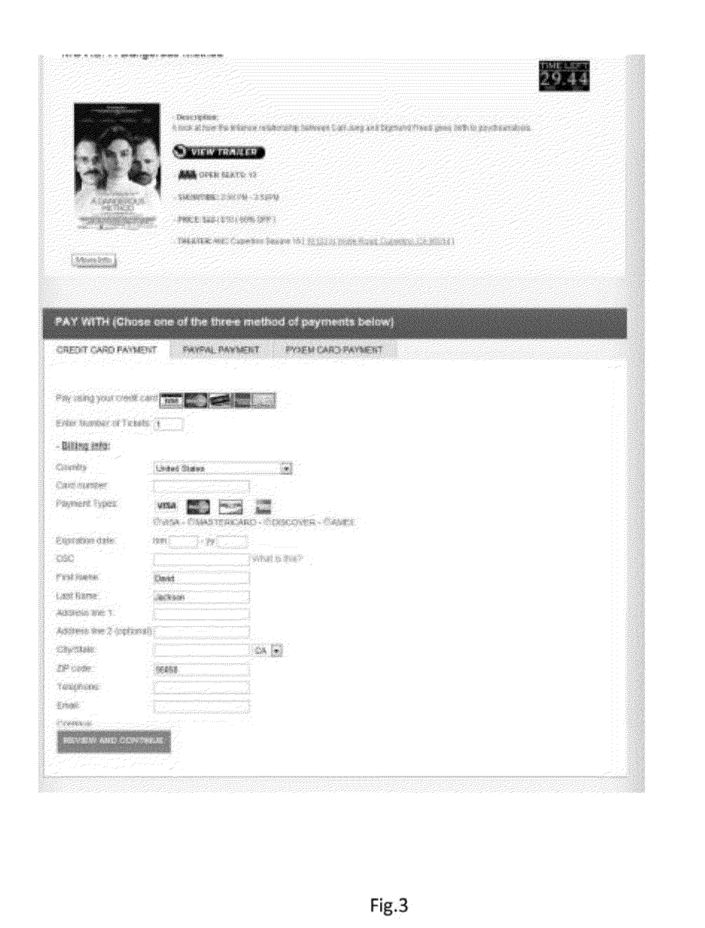

FIG. 3 illustrates a UT depicting a website providing Discount Movie Ticket in one embodiment of the present invention. As shown in FIG. 3, Prior credit verification and prior money load up of deposit for one click ticket buying (will ask for confirmation) on “PYXEM Card” (just as an example) and Regular buying option where the credit card verification happens as the ticket is purchased are provided. Buying through Pay Pal, Visa, MC, AmEx, Discover, Pyxem is also provided.

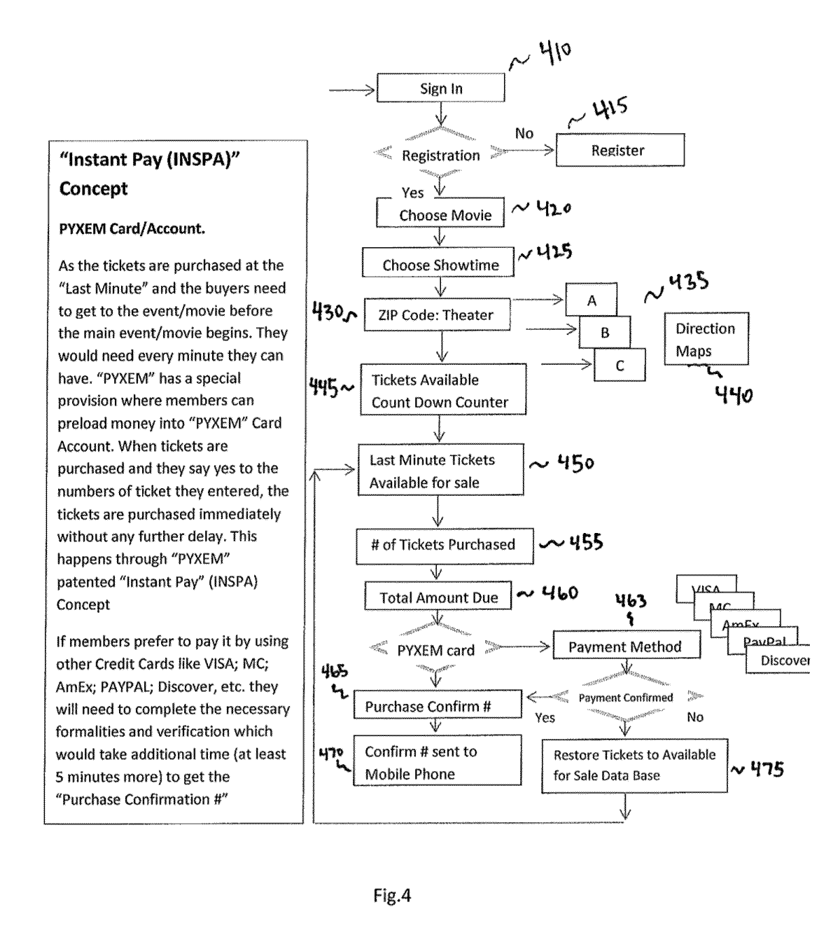

FIG. 4 illustrates an exemplary flow diagram depicting the method for Movie Ticket Discount Process in one embodiment of the present invention. As shown in FIG. 4, the whole process includes:

In exemplary step 410, a user may sign in the website. If the user is not registered, the user may be sent to registration page 415. If the user has previously been registered, the user signs in, the user proceeds to exemplary step 420 where the user selects the movie (or event) he or she wishes to watch/attend.

The user will get a target event or ticket information by taking the exemplary steps of choosing a movie 420, choosing a show time 425, and choosing the location of the target theater which can be location style or Zip Code 430. The direction map of the target theater for the target event may be provided 435. If there are at least one candidate target theaters, maps of all of the appropriate venues are provided in exemplary step 440.

In exemplary step 445, ticket availability window with a Countdown Timer (Counter) will start counting down a preset minutes prior to the opening of the ticket sale, once the preset minutes in the Countdown Timer is reached, Last Minute Tickets sale is started.

If there still remain Last Minute Tickets Available 450 for sale, the user can in exemplary step 455 select the number of tickets to be purchased within the range of the tickets available, and the system return the total amount due 460.

In exemplary step 460, the user can pay the total amount due by using the PYXEM card 460. If there is not enough money in the PYXEM card, the user also can refill the PYXEM card by using several payment methods 463.

After the payment is confirmed 465, Purchase (sale) Confirmation Number is generated, and sent to the user 470, normally sent to the user terminal, such as PC, tablet or mobile phone of the user according to the profile the user fills when registering in the system or the user terminal the user uses to sign in the system.

The user will give the Purchaser Confirmation Number (PCN) 465 along with his/her Identification (ID) at the theater gate and will be subsequently allowed to the enter the theater running their chosen movie.

If the payment fails, restore the ticket to Available for Sale Database 475.

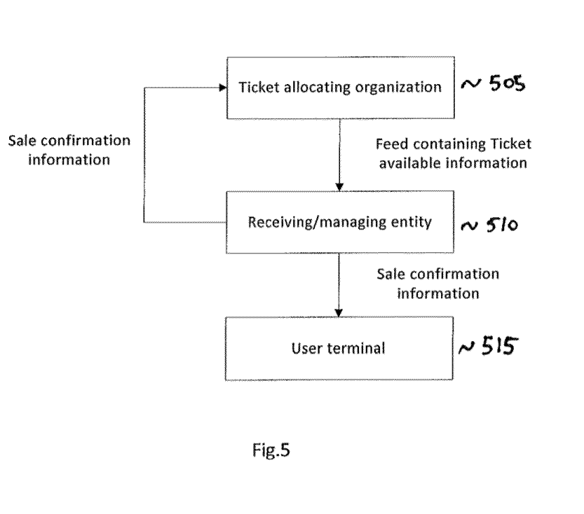

FIG. 5 is an exemplary block diagram generally illustrating an exemplary system for Perpetual Cyber Value Add Discount Process in one embodiment of the present invention. As shown in FIG. 5, the system includes:

A ticket allocating organization 505, adapted to decide how many tickets are to be allocated and send the feed containing the information to a receiving/managing entity;

a receiving/managing entity, adapted to sell the available/allocated tickets, generate a sale confirmation number for the customer who buys the ticket and simultaneously sends the sale confirmation number to a customer or user terminal 515 and the ticket allocating organization;

wherein the ticket allocating organization has internal mechanism to furnish the sale confirmation number at the gate to allow the respective customers to enter the service for which the ticket is brought.

The receiving/managing entity has its “API” developed so that the control for selling, adjusting, and transferring of funds for the allocated ticket is maintained by the receiving/managing entity without having more than necessary burden on the ticket allocating organizations.

The receiving/managing entity has most if not all of the mechanism to make the transaction user friendly and fast, which activates optionally automatically without user intervention with the receipt of the above explained dynamic feeds from partner organizations dispensing ticket sales confirmation numbers simultaneously, to multiple locations.

Further embodiments of the present invention provide for mobile applications for the receiving/managing entity 510.

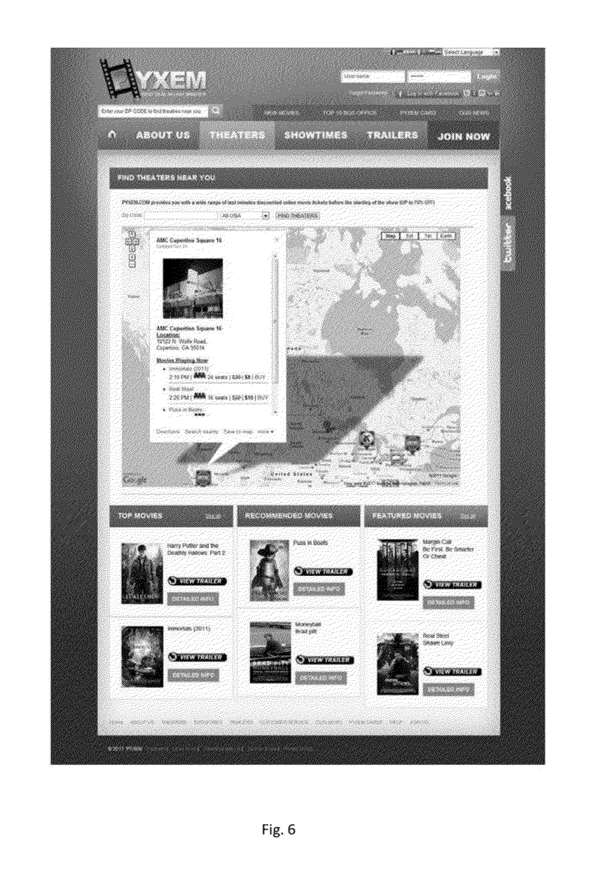

FIG. 6 is an exemplary embodiment of the present invention where the time it takes the customer to reach the venue is calculated based on software such as GOOGLE maps or any other Internet mapping service application and technology that powers map-based services that offer, for example, street maps, route planner for traveling by foot, car, bike, or public transportation. In another embodiment, the time it takes the customer to reach the service venue is calculated based on traffic information, which is calculated based on web software providing real-time traffic flow and mapping service application and technology.

In an embodiment of the present invention, a computer-readable storage medium, comprising computer instructions which, responsive to being executed by a processor, cause the processor to perform operations provided in the methods in the above embodiments is provided.

Aspects of the present invention may be implemented on one or more computers executing software instructions. According to one embodiment of the present invention, server and client computer systems transmit and receive data over a computer network or a fiber or copper-based telecommunications network (or any other communication medium). Accessing, downloading, and manipulating the data, as well as other aspects of the present invention are implemented by central processing units (CPU) in the server and client computers executing sequences of instructions stored in a memory. The memory may be random access memory (RAM), read-only memory (ROM), a persistent store, such as a mass storage device, or any combination of these devices. Execution of the sequences of instructions causes the CPU to perform functions according to embodiments of the present invention.

The instructions may be loaded into the memory of the server or client computers from a storage device or from one of more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the instructions may not be directly executable by the CPU, and may instead be executed by an interpreter that interprets the instructions. In other embodiments, hardwired circuitry may be used in place of, or in combination with, software instructions to implement the present invention. Thus, embodiments of the present invention are not limited to any specific combination of hardware circuitry and software, nor to any particular source for the instructions executed by the server or client computers. In some instances, the client and server functionality may be implemented on a single computer platform.

Aspects of the present invention can be used in a distributed electronic commerce application that includes a client/server network system that links one or more server computers to one or more client computers. The client and server computers may be implemented as desktop personal computers, workstation computers, mobile computers, portable computing devices, personal digital assistant (PDA) devices, cellular telephones, digital audio or video playback devices, or any other similar type of computing device. For purposes of the following description, the terms “computer network” and “online” may be used interchangeably and do not imply a particular network embodiment or topography. In general, any type of network (e.g., LAN, WAN, Internet or any communication medium) may be used to implement the online or computer networked implementation of the software.

In sum, the embodiments of the present invention provide for method and system for perpetual cyber value add discount process to monetize unsold tickets for an event including dynamic feeds from the participating organizations for providing particular event/show time; number of tickets allocated; and interactive communication feed generating sale confirmation numbers for the customers.

It should be understood that all of embodiments disclosed in the present invention can be combined or separated, which still should be considered within the scope of the present invention.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

1. A method for Perpetual Cyber Value Add Discount Process, comprising:
identifying a number of available tickets for a service provided by an organization which will be unused;
selling the available tickets to a customer prior to the start of the service for which the ticket is bought;
generating a sale confirmation number to the customer which allows the customer to access the service; and
sending the sale confirmation number information to the customer and the organization providing the service.

2. The method of claim 1, wherein, the number of available tickets is provided dynamically.

3. The method of claim 1, wherein, the number of available tickets is provided in a static format including a fixed number, fixed percentage or other set amount of tickets.

4. The method of claim 1, wherein, the time prior to the start of the service is shown with a timer that counts down a preset time period prior to the start of the service.

5. The method of claim 4, wherein, the preset time period is dependent on the time it takes the customer to reach a venue for the service.

6. The method of claim 1, wherein, the service is selected from the group consisting of movies, cinemas, theaters, concerts, games, fundraisers, travel tickets, amusement parks, cruises, hotels, motels, and car rentals.

7. The method of claim 1, wherein, an advertisement platform for third party advertisers to publish their advertisements is implemented.

8. The method of claim 5, wherein, the time it takes the customer to reach the service venue is calculated based on traffic information.

9. The method of claim 5, wherein, the time it takes the customer to reach the service venue is calculated based on the distance of the customer from the service venue.

10. An apparatus for Perpetual Cyber Value Add Discount Process, comprising:
means for identifying a number of unused, available tickets for a service provided by an organization;
means for selling the available tickets to a customer prior to the start of a service for which the ticket is bought;
means for generating a sale confirmation number to the customer which allows the customer to access the service; and
means for sending the sale confirmation number information to the customer and the organization providing the service.

11. The apparatus of claim 10, further comprising Application Programming Interfaces for selling adjusting, and transferring available tickets.

12. The apparatus of claim 10, wherein, the number of available unused tickets is received from an organization.

13. The apparatus of claim 10, wherein, a prepaid credit card for a particular subscriber who would preload his account for one-click ticket purchase is implemented.

14. The apparatus of claim 10, wherein, government announcements are supported.

15. The apparatus of claim 10, wherein, an algorithm in the database for calculating flexible discount to bring maximum benefits are provided.

16. A computer-readable storage medium, comprising computer instructions which, responsive to being executed by a processor, cause the processor to perform operations comprising:
identifying a number of available tickets for a service provided by an organization which are likely to remain unused;
selling the available tickets to a customer prior to the start of the service for which the ticket is bought;
generating a sale confirmation number to the customer which allows the customer to access the service; and
sending the sale confirmation number information to the customer and the organization providing the service.

17. The computer-readable storage medium of claim 16, wherein, the number of available tickets are unused is received from an organization.

18. The computer-readable storage medium of claim 16, wherein, the confirmation number information is further sent to the organization.

19. The computer-readable storage medium of claim 16, wherein, a prepaid credit card for a subscriber who would preload his account for one-click ticket purchase is implemented.

20. The computer-readable storage medium of claim 16, wherein, an algorithm in the database for calculating flexible discount to bring maximum benefits is provided.
